(19) United States
(12) Patent Application Publication
(10) Pub. No.: US 2025/0169396 A1
(43) Pub. Date: May 29, 2025

(54) CUTTING DECK HEIGHT ADJUSTMENT FOR A RIDING LAWN MOWER

(71) Applicant: HUSQVARNA AB, Huskvarna (SE)

(72) Inventor: John Southwell, Huntersville, NC (US)

(21) Appl. No.: 18/724,779

(22) PCT Filed: Dec. 27, 2021
(86) PCT No.: PCT/US2021/065197

§ 371 Date: Jun. 27, 2024

(51) Int. Cl. A01D 34/74; A01D 34/64; G05G 1/46; G05G 5/03

(52) U.S. Cl. CPC A01D 34/74; A01D 34/64; G05G 1/46; G05G 5/03

(57) ABSTRACT

A riding lawn care vehicle (10) includes a frame (60, 120) to which wheels of the riding lawn care vehicle are attached, a seat (20) in which an operator of the riding lawn care vehicle is positioned when operating the riding lawn care vehicle, a cutting deck (140) that comprises a cutting blade and a housing frame, wherein the housing frame is configured to support a housing inside which the cutting blade is housed, and a deck height adjustment assembly (150) that comprises a carriage assembly (154) and a rotary assembly (152), wherein the carriage assembly and the rotary assembly are operable by the operator positioned in the seat. The carriage assembly couples the frame of the riding lawn care vehicle to the cutting deck of the riding lawn care vehicle, and the rotary assembly is configured to set a height for the cutting deck.

### TECHNICAL FIELD

Example embodiments generally relate to lawn care vehicles with a center mounted cutting deck and, more particularly, to a height adjustment system for adjusting the cutting deck height of such a lawn care vehicle.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines and are relatively inexpensive. Meanwhile, at the other end of the spectrum, riding lawn mowers, such as zero turn mowers and lawn tractors, can be quite large. Riding lawn mowers provide the convenience of a riding vehicle as well as a typically larger cutting deck as compared to a walk-behind model. Similarly, riding lawn care vehicles typically provide users with increased convenience by enabling them to perform the yard maintenance tasks faster without exerting effort to push or walk with a vehicle.

As can be appreciated from the description above, riding lawn care vehicles may come in many different sizes and may have wide variances in their capabilities. However, beyond mere changes in size and function, riding lawn care vehicles can also be produced with a great deal of precision in relation to the configurations via which various ones of the functions they can perform are provided. For example, some riding yard maintenance vehicles may have cutting decks mounted between the front and rear wheels with an adjustable height. Depending on the particular scenario, the user may desire to alter the height of the cutting deck in order to achieve a particular length of cut for the yard. Thus, it may be advantageous to provide an assembly that is capable of reducing the time and effort required to adjust the height of the cutting deck.

### BRIEF SUMMARY OF SOME EXAMPLES

Some example embodiments may provide for a deck height adjustment assembly for a riding lawn care vehicle. The assembly may include a carriage assembly that may operably couple a frame of the riding lawn care vehicle to a cutting deck of the riding lawn care vehicle, and a rotary assembly that may be configured to set a height for the cutting deck. The carriage assembly and the rotary assembly may each be operable by an operator of the riding lawn care vehicle from an operating position of the riding lawn care vehicle.

Some example embodiments may provide for a riding lawn care vehicle. The riding lawn care vehicle may include a frame to which wheels of the riding lawn care vehicle may be attachable, a seat in which an operator of the riding lawn care vehicle may be positioned when operating the riding lawn care vehicle, a cutting deck that may be operably coupled to the frame and may comprise a cutting blade and a housing frame, wherein the housing frame may be configured to support a housing inside which the cutting blade is housed, and a deck height adjustment assembly that may comprise a carriage assembly and a rotary assembly, wherein the carriage assembly and the rotary assembly may be operable by the operator positioned in the seat.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A illustrates a perspective view of a riding lawn care vehicle according to an example embodiment;

FIG. 1B illustrates a top view of the riding lawn care vehicle according to an example embodiment;

FIG. 2 illustrates a side view of the riding lawn care vehicle according to an example embodiment;

FIG. 3 illustrates a schematic block diagram of a riding lawn care vehicle according to an example embodiment;

FIG. 4A illustrates a perspective view of a deck height adjustment assembly according to an example embodiment;

FIG. 4B illustrates a close-up perspective view of a rotary assembly from the deck height adjustment assembly of FIG. 4A according to an example embodiment;

FIG. 4C illustrates a close-up perspective view of a rotary assembly from the deck height adjustment assembly of FIG. 4A according to an example embodiment;

FIG. 4D illustrates a close up perspective view of a carriage assembly from the deck height adjustment assembly of FIG. 4A according to an example embodiment;

FIG. 4E illustrates a close up perspective view of the connection between the carriage assembly and the rotary assembly from the deck height adjustment assembly of FIG. 4A according to an example embodiment;

FIG. 5 illustrates a top view of a rotary selector according to an example embodiment; and

FIG. 6 illustrates a top view of a rotary selector according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. Additionally, the term “lawn care” is meant to relate to any yard maintenance activity and need not specifically apply to activities directly tied to grass, turf or sod care. As used herein, operable coupling should be understood to relate to direct or indirect connection that, in either case, enables functional interconnection of components that are operably coupled to each other. Although terms such as equipment, attachment, accessory and/or the like may each be used to generally interchangeably to describe components of various devices, some of these terms may be used to differentiate certain components of example embodiments for purposes of clarity.

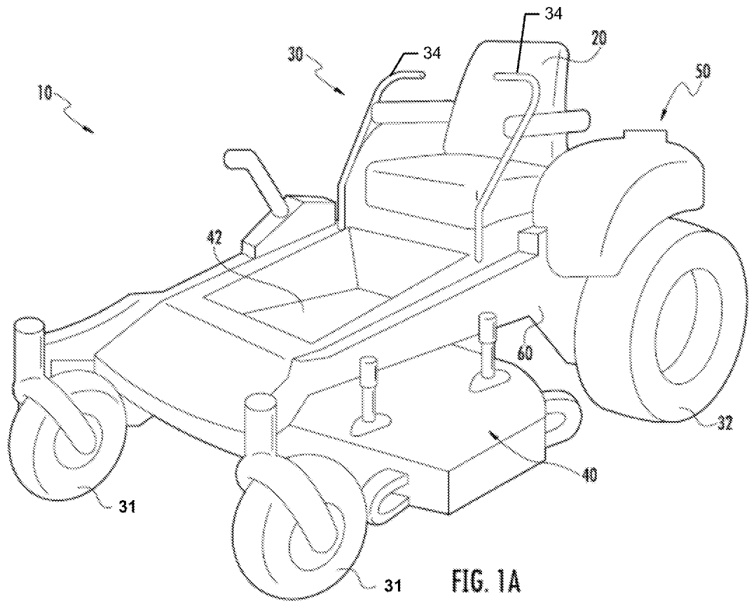

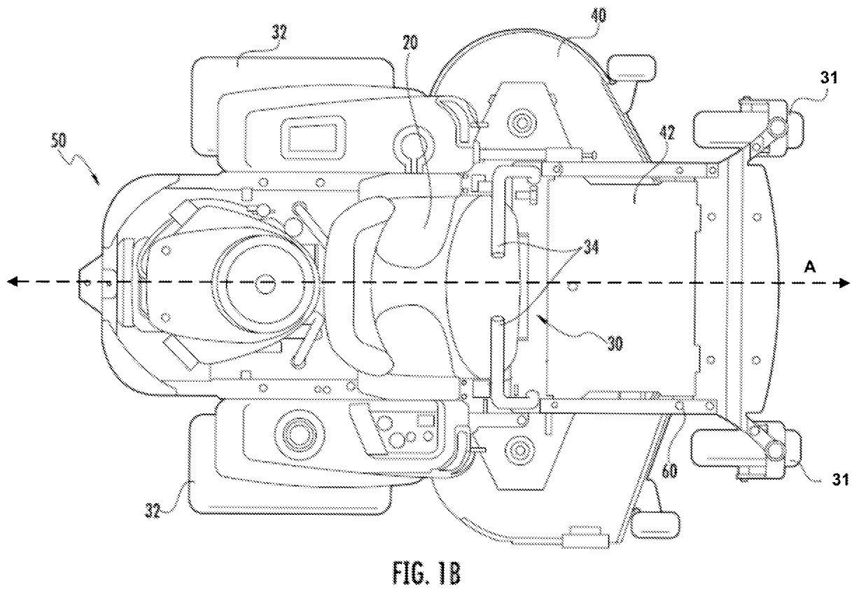

FIG. 1A illustrates a perspective view of a riding lawn care vehicle 10 and FIG. 1B illustrates a top view of the riding lawn care vehicle 10 according to an example embodiment. The riding lawn care vehicle 10 may include a seat 20 that may be disposed at a center, rear, or front portion of the riding lawn care vehicle 10. The riding lawn care vehicle 10 may also include a steering assembly 30 (e.g., a set of steering levers or the like) functionally connected to wheels 31 and/or 32 of the riding lawn care vehicle 10 to allow the operator to steer the riding lawn care vehicle 10.

In the depicted example, the operator may sit on the seat 20, which may be disposed between steering levers 34 of the steering assembly 30 to provide input for steering of the riding lawn care vehicle 10 via the steering assembly 30. The riding lawn care vehicle 10 may also include a cutting deck 40 having at least one cutting blade (e.g., three cutting blades) mounted therein. The cutting deck 40 may be positioned substantially rearward of a pair of front wheels 31 and substantially forward of a pair of rear wheels 32 in a position to enable the operator to cut grass using the cutting blade(s) when the cutting blade(s) are rotated below the cutting deck 40 when the cutting deck 40 is in a cutting position.

In some embodiments, a footrest 42 may also be positioned above the cutting deck 40 forward of the seat 20 to enable the operator to rest his or her feet thereon while seated in the seat 20. In the pictured embodiment, an engine 50 of the riding lawn care vehicle 10 is disposed to the rear of a seated operator. However, in other example embodiments, the engine 50 could be in different positions such as in front of or below the operator. The engine 50 may be operably coupled to one or more of the wheels 31 and/or 32 (in this case only to the rear wheels 32) to provide drive power for the riding lawn care vehicle 10. The engine 50, the steering assembly 30, the cutting deck 40, the seat 20, and other components of the riding lawn care vehicle 10 may be operably connected (directly or indirectly) to a frame 60 of the riding lawn care vehicle 10. The frame 60 may be a rigid structure configured to provide support, connectivity, and/or interoperability functions for various ones of the components of the riding lawn care vehicle 10.

As can be appreciated from FIG. 1A, the footrest 42 may be substantially lower (in elevation) than the seat 20 in order to comfortably support a seated operator on the seat 20. This results in an elevated seat 20 that is disposed atop a seat mounting structure that is operably coupled to the frame 60. In some embodiments, such as the one depicted in FIGS. 1A and 1B, the riding lawn care vehicle may be of the type to have a zero or near zero degree radius of turn. However, in other embodiments, other types of riding lawn care vehicles may be used.

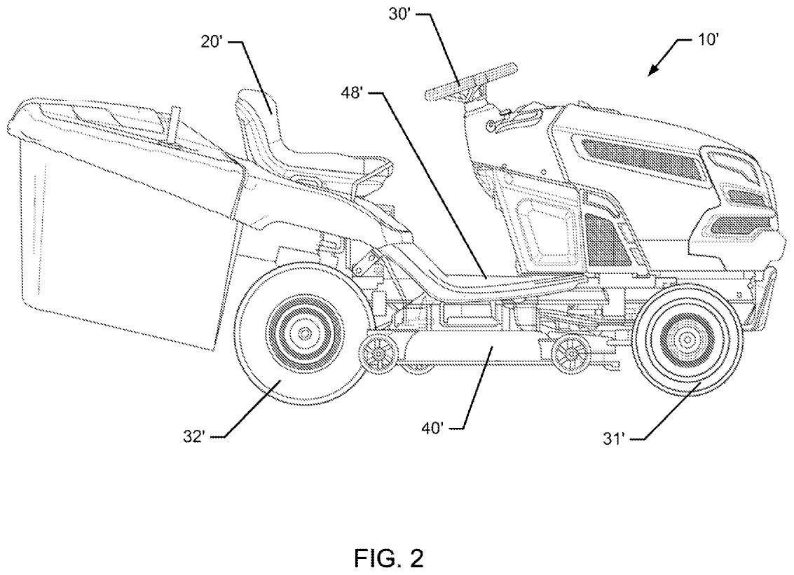

FIG. 2 illustrates a riding lawn care vehicle 10′ of a lawn tractor type. The riding lawn care vehicle 10′ may include a seat 20′ that may be disposed at a center, rear, or front portion of the riding lawn care vehicle 10′, and a steering assembly 30′ (e.g., including a steering wheel, handle bars, or other steering apparatus) functionally connected to wheels 31′ and/or 32′ of the riding lawn care vehicle 10′ to which steering inputs are provided (e.g., the front and/or rear wheels in various different embodiments) to allow the operator to steer the riding lawn care vehicle 10′. The operator may sit on the seat 20′, which may be disposed to the rear of a steering assembly 30′ to provide input for steering of the riding lawn care vehicle 10′ via the steering assembly 30′.

The riding lawn care vehicle 10′ may also include, or be configured to support attachment of, a cutting deck 40′ having at least one cutting blade mounted therein. In some cases, a height of the at least one cutting blade may be adjustable by an operator of the riding lawn care vehicle 10′. The cutting deck 40′ may be a fixed or removable attachment in various different embodiments. In some embodiments, the cutting deck 40′ may be lifted or rotated relative to the lawn mower frame to permit easier access to the underside of the lawn mower without requiring removal of the cutting deck 40′. The cutting deck 40′ may have one, two, three, or more cutting blades driven by one, two, three, or more rotatable shafts. The shafts may be rotated by any number of mechanisms. For example, in some embodiments, the shafts are coupled to a motor via a system of belts and pulleys. In other embodiments, the shafts may be coupled to the motor via a system of universal joints, gears, and/or other shafts. In still other embodiments, such as in an electric lawn mower, the shaft may extend directly from an electric motor positioned over the cutting deck.

The riding lawn care vehicle 10′ may also include additional control-related components such as one or more speed controllers, brakes, cutting height adjusters, and/or the like. Some of the controllers, such as the speed controllers and/or brakes, may be provided in the form of foot pedals that may sit proximate to a footrest 48′ (which may include a portion on both sides of the riding lawn care vehicle 10′) to enable the operator to rest his or her feet thereon while seated in the seat 20′. In some embodiments, one such control-related component may be a cutting deck height adjustment assembly, which may include a foot pedal to lift the cutting deck away from a cutting position. More details on the deck height adjustment assembly will be discussed below in reference to later figures.

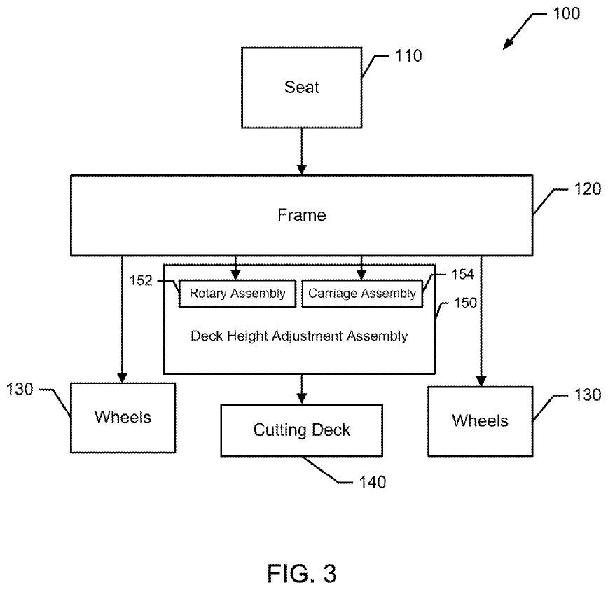

FIG. 3 illustrates a simplified block diagram of a riding lawn care vehicle 100 according to an example embodiment. The riding lawn care vehicle 100 may be an example of either a zero turn mower (the embodiment described in FIGS. 1A and 1B), a lawn tractor (the embodiment described in FIG. 2), or any other form of riding lawn care vehicle 100. As shown in FIG. 3, the riding lawn care vehicle 100 may include a seat 110, a frame 120, wheels 130, a cutting deck 140, and a deck height adjustment assembly 150. In some embodiments, the cutting deck 140 may be operably coupled to the frame 120 via the deck height adjustment assembly 150. The deck height adjustment assembly 150 may include a rotary assembly 152 and a carriage assembly 154. Both the rotary assembly 152 and the carriage assembly 154 may operably couple the deck height adjustment assembly 150 to the frame 120. Additionally, both the rotary assembly 152 and the carriage assembly 154 may include components intended to be interacted with by the operator of the riding lawn care vehicle 100. Accordingly, these components may be within reasonable reach of the seat 110 such that an operator may interact with both the rotary assembly 152 and the carriage assembly 154, while seated in the seat 110, in order to set a height of the cutting deck 140. In this regard, setting the height of the cutting deck 140 via the deck height adjustment assembly 150 may involve the operator utilizing the carriage assembly 154 to elevate the cutting deck 140 away from a cutting position and into an elevated position. While maintaining the cutting deck 140 in the elevated position, the operator may then utilize the rotary assembly 152 to select a desired height for the cutting deck 140 to assume upon being released from the elevated position. The operator may then release the cutting deck 140 from the elevated position and the cutting deck 140 may lower into a new height as desired.

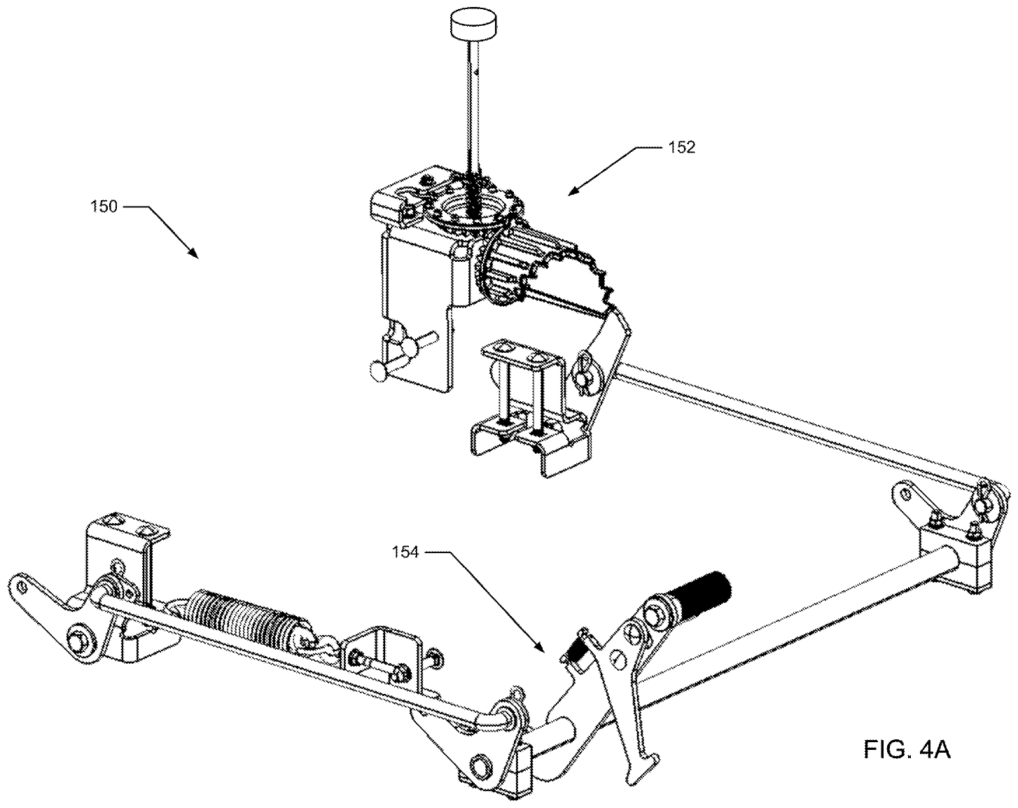

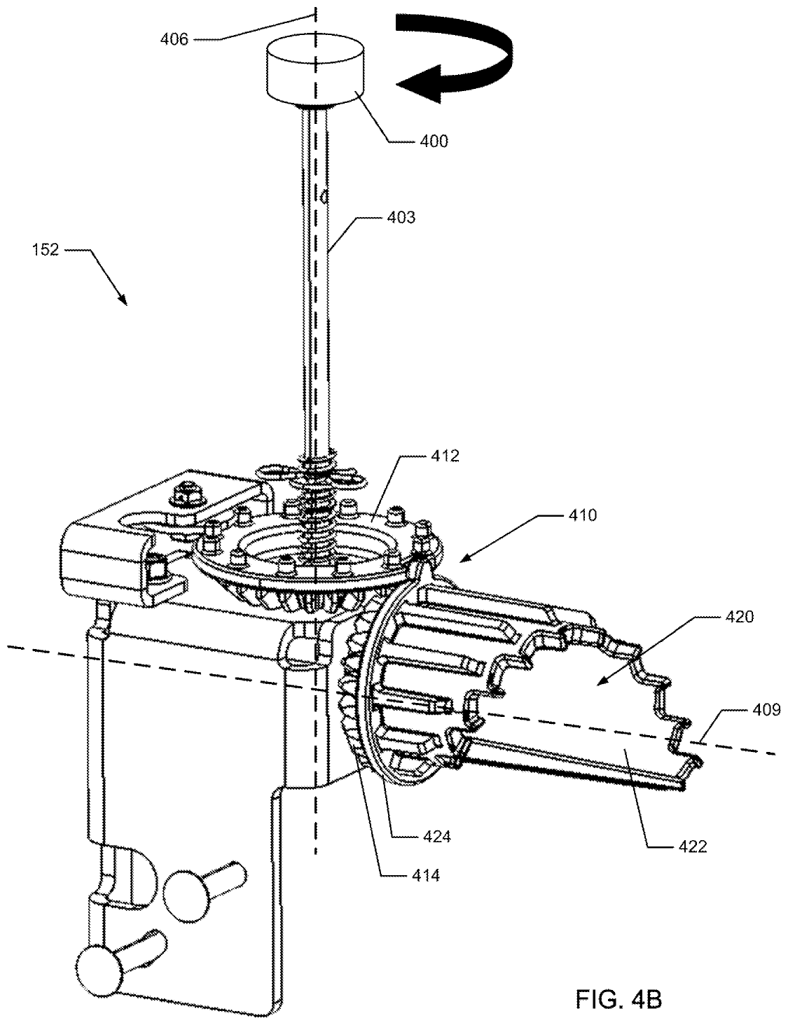

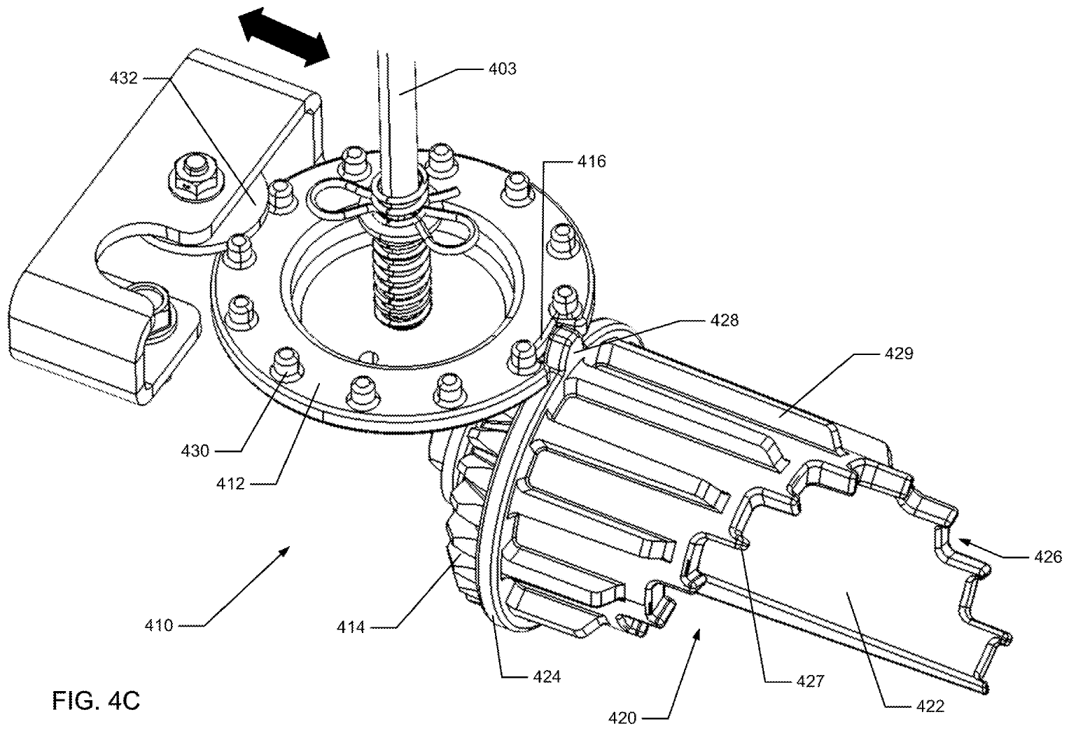

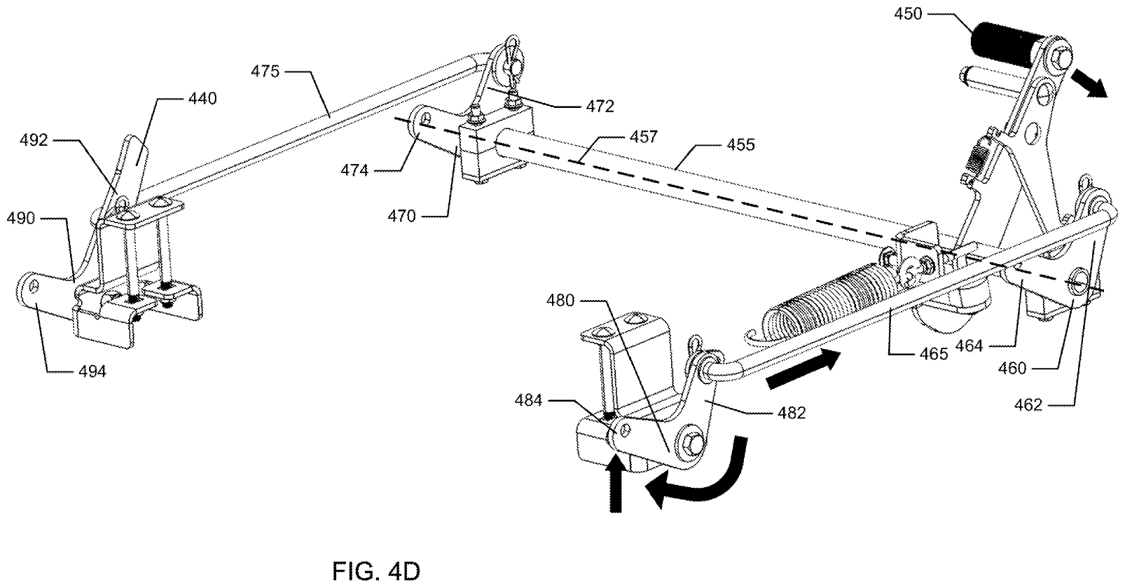

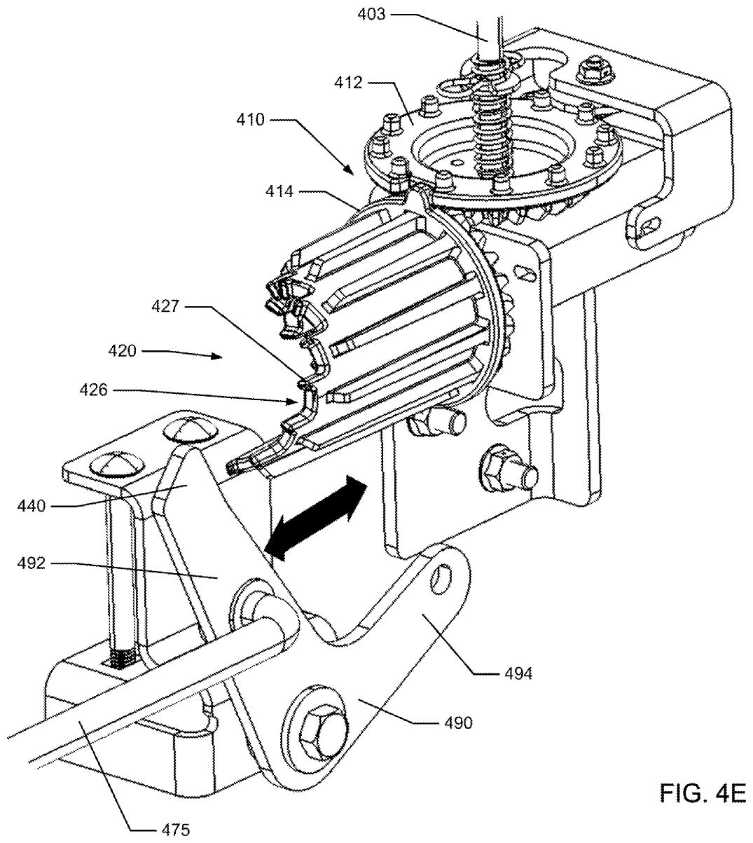

FIG. 4A illustrates a perspective view of the entire deck height adjustment assembly 150 according to an example embodiment. The deck height assembly 150 shown in FIG. 4A may include the rotary assembly 152 operably coupled to the carriage assembly 154. FIGS. 4B, 4C, 4D, and 4E depict close up views of the rotary assembly 152 and the carriage assembly 154. Accordingly, the rotary assembly 152 and the carriage assembly 154 will be discussed separately with respect to later figures below.

FIGS. 4B and 4C illustrate close up perspective views of the rotary assembly 152 from the deck height adjustment assembly 150 of FIG. 4A. The rotary assembly 152 may comprise a rotary selector 400, a bevel gear assembly 410, and a deck height spacer 420. In some embodiments, the rotary selector 400 may be a rotatable selector mechanism. The rotary selector 400 may be disposed on the frame and may also be within reasonable reach of the seat 110. The rotary selector 400 may be configured to be rotated by the operator in order to select a desired height for the cutting deck 140 to operate at. In this regard, the rotary selector 400 may be operably coupled to the bevel gear assembly 410 via a shaft 403. The shaft 403 may be configured to transfer all rotational torque applied to the rotary selector 400 by the operator to the bevel gear assembly 410. In some embodiments, the bevel gear assembly 410 may include a first bevel gear 412 and a second bevel gear 414. The first bevel gear 412 may be fixedly operably coupled to the shaft 403. As such, the shaft 403 may transfer all rotational torque from the rotary selector 400 to the first bevel gear 412 of the bevel gear assembly 410. In this regard, the rotary selector 400, the shaft 403 and the first bevel gear 412 may all be coaxial about a first axis 406 of rotation.

The second bevel gear 414 may be disposed at an angle to the first bevel gear 412 and may rotate about a second axis 409 of rotation. In this regard, the second bevel gear 414 may be disposed such that an angle between the first axis 406 and the second axis 409 may be roughly 90 degrees. The first bevel gear 412 may be configured to transfer all rotational torque from the rotary selector 400 to the second bevel gear 414 via the interaction of gear teeth between the first bevel gear 412 and the second bevel gear 414 in the bevel gear assembly 410. In some embodiments, the gear teeth on the first bevel gear 412 may be disposed at an angle between 0 degrees and 90 degrees so that they may effectively interlace with the gear teeth on the second bevel gear 414, which may also be disposed at an angle between 0 degrees and 90 degrees.

In the embodiment depicted in FIGS. 4B and 4C, the second bevel gear 414 may be disposed at an end of, and fixedly operably coupled to, the deck height spacer 420. In some embodiments, the deck height spacer 420 and the second bevel gear 414 may be coaxial about the second axis 409. In this regard, the second bevel gear 414 may be configured to transfer all rotational torque from the rotary selector 400 to the deck height spacer 420. In some cases, the deck height spacer 420 may be embodied as a cylindrical body which may include a circumferential surface 422 and a base portion 424. In some cases, the base portion 424 may be operably coupled to the second bevel gear 414. The circumferential surface 422 of the deck height spacer 420 may extend in a direction normal to the base portion 424 at a constant radius around the second axis 409. The circumferential surface 422 may also include a plurality of radial segments 426 formed therein. In this regard, the circumferential surface 422 of the deck height spacer 420 may include a step-like structure wherein each of the plurality of radial segments 426 may be disposed a greater distance away from the base portion 424 than a previous radial segment 426 in a clockwise direction around the circumferential surface 422. The circumferential surface 422 may also include a plurality of reinforcement members 429 that may be disposed on an exterior of the circumferential surface 422. In some embodiments, the reinforcement members 429 may align with individual radial segments 426 of the deck height spacer 420. In this regard, the reinforcement members 429 may help the radial segments 426 to withstand any forces exerted thereon. In some embodiments, each radial segment 426 may also include a retaining lip 427 protruding in the axial direction perpendicular to the base portion 424. The retaining lip 427 may occupy a position on an edge of the radial segment 426 so that the radial segment 426 may better retain an object without the object inadvertently dropping down into a neighboring radial segment 426. In some embodiments, the deck height spacer 420 may comprise a total of 12 radial segments 426. In this regard, each radial segment 426 may occupy a sector of roughly 30 degrees with respect to the total 360 degrees of the cylindrical body. In some embodiments, the bevel gear assembly 410 may be configured such that a full range of radial segments 426 may be covered with one full rotation of the rotary selector 400. As such, the operator may not need to rotate the rotary selector 400 more than one full rotation in order to reach a desired setting. More details on the radial segments 426 and retaining the object will be described below in reference to the carriage assembly 154.

In some embodiments, the base portion 424 may include a reference protrusion 428. The reference protrusion 428 may be configured to align with a reference notch 416 that may be cut into the first bevel gear 412. In this regard, the alignment of the reference protrusion 428 with the reference notch 416 may indicate that the rotary assembly 152 may be installed in a correct position such that a plurality of height indications on the frame 120 proximate to the rotary selector 400, correspond to the proper radial segments 426 on the deck height spacer 420.

FIGS. 4B and 4C also depict a plurality of protrusions 430 disposed on a top face of the first bevel gear 412. The protrusions 430 may be configured to interact with a washer 432 proximate to the top face of the first bevel gear 412. In some embodiments, the washer 432 may be biased towards the first bevel gear 412 via a spring (not shown). In this regard, the washer 432 may provide tactile feedback to the operator applying the rotational torque to the rotary selector 400. In other words, as the operator turns the rotary selector 400, the shaft 403 transmits the rotational torque to the first bevel gear 412 which then rotates about axis 406 accordingly. As the first bevel gear 412 rotates, the protrusions 430 also rotate around the first axis 406 and, in doing so, come into contact with the washer 432. As such, the protrusions 430 may push the washer 432 away from the first bevel gear 412 as the protrusions 430 rotate around. However, the washer 432 may move towards the first bevel gear 412 as the first bevel gear 412 rotates responsive to lining up between two consecutive protrusions 430. In this regard, the repeated back and forth motion of the washer 432, that may be ultimately induced by the operator rotating the rotary selector 400, may accordingly generate a clicking noise and feeling that may provide a sense of tactile feedback to the operator at the rotary selector 400 to indicate the passing or selecting of one of a plurality of height selections.

FIG. 4D illustrates a close up perspective view of the carriage assembly 154 from the deck height adjustment assembly 150 of FIG. 4A. The carriage assembly 154 may include a height selector arm 440, a foot pedal 450, a pivot bar 455, a first bell crank 460, a second bell crank 470, a third bell crank 480 and a fourth bell crank 490. The carriage assembly 154 may be configured to lift the cutting deck 140 responsive to the operator depressing the foot pedal 450. In some embodiments, the foot pedal 450 may be fixedly operably coupled to the pivot bar 455. In this regard, as the foot pedal 450 is depressed by the operator, the foot pedal 450 may pivot with the pivot bar 455 about an axis 457. The pivot bar 455 may be fixedly operably coupled to the first bell crank 460 at a first end of the pivot bar 455 and to the second bell crank 470 at a second end of the pivot bar 455. In this regard, as the pivot bar 455 rotates responsive to the operator applying a force on the foot pedal 450, the first bell crank 460 and the second bell crank 470 may each also pivot about axis 457.

The first bell crank 460 may include a first arm 462 that may be operably coupled to a first linking rod 465, and a second arm 464 that may be operably coupled to the cutting deck 140. Similarly, the second bell crank 470 may include a first arm 472 that may be operably coupled to a second linking rod 475, and a second arm 474 that may be operably coupled to the cutting deck 140. The first and second linking rods 465 and 475 may operably couple the first and second bell cranks 460 and 470 with the third and fourth bell cranks 480 and 490, respectively. In this regard, the first bell crank 460 may be operably coupled to a first arm 482 of the third bell crank 480 via the first linking rod 465. Similarly, the second bell crank 470 may be operably coupled to a first arm 492 of the fourth bell crank 490 via the second linking rod 475. In this regard, responsive to the operator interacting with the foot pedal 450, the linking rods 465 and 475 may be configured to transfer force from the first and second bell cranks 460 and 470 to the third and fourth bell cranks 480 and 490, respectively. Accordingly, the third and fourth bell cranks 480 and 490 may each pivot a same amount as the first and second bell cranks 460 and 470. The third and fourth bell cranks 480 and 490 may also include second arms 484 and 494 which may also be operably coupled to the cutting deck 140. Therefore, responsive to the operator depressing the foot pedal 450 in FIG. 4D, each of the first, second, third and fourth bell cranks (460, 470, 480, and 490) may pivot such that the first arms (462, 472, 482, and 492) may each move towards a distal end of the foot pedal 450. Accordingly, the second arms (464, 474, 484, and 494) may each move in the same direction, but, in doing so, the second arms (464, 474, 484, and 494) may lift the cutting deck 140 away from a surface on which the riding lawn care vehicle 100 may operate. In this regard, FIG. 4D illustrates that, as the foot pedal 450 may be depressed, the first linking rod 465 may impart a linear force on the third bell crank 480 to pull the first arm 482 towards the foot pedal 450. Accordingly, the third bell crank 480 may rotate clockwise, and thus, the second arm 484 may pull up on the cutting deck 140. A similar set of actions may occur simultaneously with respect to the second linking rod 475 and the fourth bell crank 490.

FIG. 4E depicts a close up perspective view of the connection structure between the carriage assembly 154 and the rotary assembly 152 according to an example embodiment. As shown in FIG. 4E, the height selector arm 440 may move from an engaged state to a disengaged state responsive to the operator depressing the foot pedal 450 and the fourth bell crank 490 pivoting. In this regard, when the operator applies a force on the foot pedal 450, the height selector arm 440 may move to the disengaged state where the height selector arm 440 does not come into contact with any other components of the deck height assembly 150. For clarification purposes, FIG. 4E depicts the height selector arm 440 in the disengaged state. On the other hand, when the carriage assembly 154 is in a resting position (e.g. with no forces applied to the foot pedal 450 and the cutting deck 140 in a cutting position) the height selector arm 440 may be in the engaged state where it is in contact with a given radial segment 426 of the deck height spacer 420. Accordingly, the deck height spacer 420, and the given radial segment 426, may support the fourth bell crank 490 and the height selector arm 440 in one of a plurality of positions responsive to the operator releasing the foot pedal 450. In other words, depending on a particular height selected by the operator at the rotary selector 400, the deck height spacer 420 may rotate to position a corresponding radial segment 426 with the height selector arm 440 such that the radial segment 426 supports the height selector arm 440 in the engaged state. Accordingly, the retaining lip 427 may secure the height selector arm 440 within a desired radial segment 426 such that the height selector arm 440 does not leave the engaged state with the radial segment 426 unintentionally. In this regard, each radial segment 426 may correspond to a different height to which the cutting deck 140 may be set. In other words, in order to adjust a height of the cutting deck 140 on the riding lawn care vehicle 100, the operator must simply depress the foot pedal 450, and with the foot pedal 450 depressed, turn the rotary selector 400 to a desired height setting. Upon releasing the foot pedal 450, the cutting deck 140 may be at a new height selected by the operator.

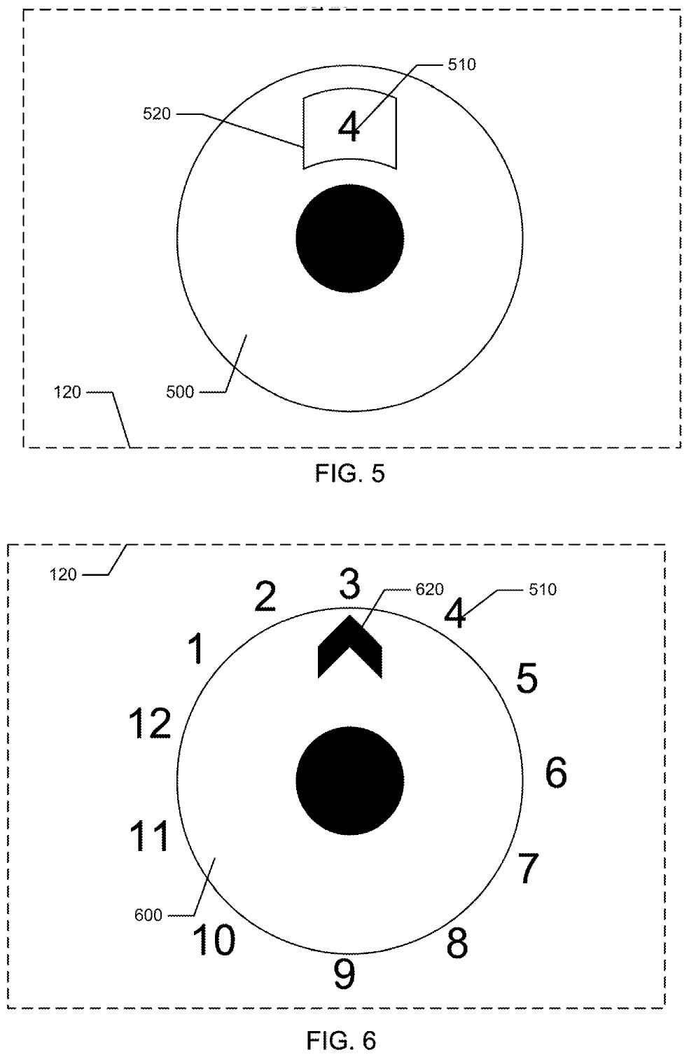

FIG. 5 depicts a rotary selector 500 according to an example embodiment. In the embodiment of FIG. 5, the riding lawn care vehicle 100 may include a plurality of height indications 510 printed on the frame 120 behind the rotary selector 500 when viewed from above. In this regard, the rotary selector 500 may include a selection indicator 520 in the form of a viewing window. In some embodiments, the selection indicator 520 may be made of a transparent material such as a plastic. In some other cases, the selection indicator 520 may simply be an empty space cut into the rotary selector 500. In any case, the rotary selector 500 may be configured such that the height indication 510 that may be visible through the viewing window may correspond to a selected height setting of the cutting deck 140. In order to change the selected height setting, the operator may rotate the rotary selector 500 in either the clockwise or counter clockwise direction. As mentioned above, a full range of height indications 510 may be covered with one full rotation of the rotary selector 500. As such, the operator may not need to rotate the rotary selector 500 more than one full rotation in order to reach a desired height indication 510.

FIG. 6 depicts a rotary selector 600 according to an example embodiment. In the embodiment of FIG. 6, the riding lawn care vehicle 100 may include a plurality of height indications 510 printed on the frame 120 around the rotary selector 600 when viewed from above. In this regard, the rotary selector 600 may include a selection indicator 620 in the form of an indicating arrow. In some embodiments, the selection indicator 620 may be painted on the rotary selector 600. In some other cases, the selection indicator 620 may formed into the rotary selector 600. In any case, the rotary selector 600 may be configured such that the height indications 510 that may be disposed at a tip of the indicating arrow may correspond to a selected height setting of the cutting deck 140. In order to change the selected height setting, the operator may rotate the rotary selector 600 in either the clockwise or counter clockwise direction. As mentioned above, a full range of height indications 510 may be covered with one full rotation of the rotary selector 600. As such, the operator may not need to rotate the rotary selector 600 more than one full rotation in order to reach a desired height indication 510.

Some example embodiments may provide for a deck height adjustment assembly for a riding lawn care vehicle. The assembly may include a carriage assembly that may operably couple a frame of the riding lawn care vehicle to a cutting deck of the riding lawn care vehicle, and a rotary assembly that may be configured to set a height for the cutting deck. The carriage assembly and the rotary assembly may each be operable by an operator of the riding lawn care vehicle from an operating position of the riding lawn care vehicle.

The deck height adjustment assembly of some embodiments may include additional features, modifications, augmentations and/or the like to achieve further objectives or enhance the performance of the deck height adjustment assembly. The additional features, modifications, augmentations and/or the like may be added in any combination with each other. Below is a list of various additional features, modifications, and augmentations that can each be added individually or in any combination with each other. For example, the rotary assembly may comprise a rotary selector, a bevel gear assembly and a deck height spacer. In an example embodiment, the rotary selector may be operably coupled to the bevel gear assembly to transmit torque from the rotary selector to the bevel gear assembly. In some cases, the bevel gear assembly may be operably coupled to the deck height spacer to transmit torque from the rotary selector to the deck height spacer. In an example embodiment, the carriage assembly may comprise a pedal and a height selector arm. In some cases, the pedal may be operably coupled to the height selector arm such that the height selector arm may move from an engaged state with the deck height spacer to a disengaged state responsive to the operator engaging the pedal. In an example embodiment, the carriage assembly may further include a pivot bar, a first bell crank, a second bell crank, a third bell crank and a fourth bell crank. In some cases, the pivot bar may operably couple the pedal to the first bell crank at a first end of the pivot bar and to the second bell crank at a second end of the pivot bar. In an example embodiment, the first bell crank may be operably coupled to the third bell crank via a first linking rod and the second bell crank may be operably coupled to the fourth bell crank via a second linking rod. In some cases, the first bell crank, the second bell crank, the third bell crank and the fourth bell crank may each be operably coupled to the cutting deck and may be configured to lift the cutting deck responsive to the operator engaging the pedal. In an example embodiment, the height selector arm may be integrated into the fourth bell crank. In some cases, the first bell crank may move the third bell crank via the first linking rod responsive to the operator engaging the pedal. In an example embodiment, the second bell crank may move the fourth bell crank via the second linking rod responsive to the operator engaging the pedal. In some cases, the deck height spacer may comprise a cylindrical body that may be operably coupled to the bevel gear assembly. In an example embodiment, the cylindrical body may comprise a circumferential surface that may extend in an axial direction, a base portion and a plurality of radial segments. In some cases, the circumferential surface of the cylindrical body may comprise a step-like structure wherein each of the plurality of radial segments may be disposed a greater distance away from the base portion than a previous radial segment in a clockwise direction around the circumferential surface. In an example embodiment, the height selector arm may be configured to contact the deck height spacer at one of the plurality of radial segments when the height selector arm may be in the engaged state. In some cases, each radial segment may comprise a retaining lip protruding in the axial direction perpendicular to the base portion which may retain the height selector arm in the engaged state. In an example embodiment, the rotary assembly may further comprise a feedback mechanism that may be configured to provide tactile feedback to the rotary selector responsive to the operator turning the rotary selector. In some cases, the feedback mechanism may comprise a washer and projections on a surface of the bevel gear assembly. In an example embodiment, the washer may be biased towards the projections and may provide a feedback response to the operator responsive to passing a projection as the bevel gear turns. In some cases, the rotary selector may comprise a selection indicator that may align with a height indication on a portion of the frame as the rotary selector may be turned by the operator. In an example embodiment, the deck height spacer may further comprise a reference protrusion on the base portion that may be configured to align with a reference notch in the bevel gear assembly which may assist with installing the rotary assembly in a proper orientation.

Some example embodiments may provide for a riding lawn care vehicle. The riding lawn care vehicle may include a frame to which wheels of the riding lawn care vehicle may be attachable, a seat in which an operator of the riding lawn care vehicle may be positioned when operating the riding lawn care vehicle, a cutting deck that may be operably coupled to the frame and may comprise a cutting blade and a housing frame, wherein the housing frame may be configured to support a housing inside which the cutting blade is housed, and a deck height adjustment assembly that may comprise a carriage assembly and a rotary assembly, wherein the carriage assembly and the rotary assembly may be operable by the operator positioned in the seat.

The riding lawn care vehicle of some embodiments may include additional features, modifications, augmentations and/or the like to achieve further objectives or enhance the performance of the riding lawn care vehicle. The additional features, modifications, augmentations and/or the like may be added in any combination with each other. Below is a list of various additional features, modifications, and augmentations that can each be added individually or in any combination with each other. For example, the rotary assembly may comprise a rotary selector, a bevel gear assembly and a deck height spacer. In an example embodiment, the rotary selector may be operably coupled to the bevel gear assembly to transmit torque from the rotary selector to the bevel gear assembly. In some cases, the bevel gear assembly may be operably coupled to the deck height spacer to transmit torque from the rotary selector to the deck height spacer. In an example embodiment, the carriage assembly may comprise a pedal and a height selector arm. In some cases, the pedal may be operably coupled to the height selector arm such that the height selector arm may move from an engaged state with the deck height spacer to a disengaged state responsive to the operator engaging the pedal. In an example embodiment, the carriage assembly may further include a pivot bar, a first bell crank, a second bell crank, a third bell crank and a fourth bell crank. In some cases, the pivot bar may operably couple the pedal to the first bell crank at a first end of the pivot bar and to the second bell crank at a second end of the pivot bar. In an example embodiment, the first bell crank may be operably coupled to the third bell crank via a first linking rod and the second bell crank may be operably coupled to the fourth bell crank via a second linking rod. In some cases, the first bell crank, the second bell crank, the third bell crank and the fourth bell crank may each be operably coupled to the cutting deck and may be configured to lift the cutting deck responsive to the operator engaging the pedal. In an example embodiment, the height selector arm may be integrated into the fourth bell crank. In some cases, the first bell crank may move the third bell crank via the first linking rod responsive to the operator engaging the pedal. In an example embodiment, the second bell crank may move the fourth bell crank via the second linking rod responsive to the operator engaging the pedal. In some cases, the deck height spacer may comprise a cylindrical body that may be operably coupled to the bevel gear assembly. In an example embodiment, the cylindrical body may comprise a circumferential surface that may extend in an axial direction, a base portion and a plurality of radial segments. In some cases, the circumferential surface of the cylindrical body may comprise a step-like structure wherein each of the plurality of radial segments may be disposed a greater distance away from the base portion than a previous radial segment in a clockwise direction around the circumferential surface. In an example embodiment, the height selector arm may be configured to contact the deck height spacer at one of the plurality of radial segments when the height selector arm may be in the engaged state. In some cases, each radial segment may comprise a retaining lip protruding in the axial direction perpendicular to the base portion which may retain the height selector arm in the engaged state. In an example embodiment, the rotary assembly may further comprise a feedback mechanism that may be configured to provide tactile feedback to the rotary selector responsive to the operator turning the rotary selector. In some cases, the feedback mechanism may comprise a washer and projections on a surface of the bevel gear assembly. In an example embodiment, the washer may be biased towards the projections and may provide a feedback response to the operator responsive to passing a projection as the bevel gear turns. In some cases, the rotary selector may comprise a selection indicator that may align with a height indication on a portion of the frame as the rotary selector may be turned by the operator. In an example embodiment, the deck height spacer may further comprise a reference protrusion on the base portion that may be configured to align with a reference notch in the bevel gear assembly which may assist with installing the rotary assembly in a proper orientation.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A deck height adjustment assembly for a riding lawn care vehicle, the deck height adjustment assembly comprising:
a carriage assembly operably coupling a frame of the riding lawn care vehicle to a cutting deck of the riding lawn care vehicle; and
a rotary assembly configured to set a height for the cutting deck,
wherein the carriage assembly and the rotary assembly are each operable by an operator of the riding lawn care vehicle from an operating position of the riding lawn care vehicle.

2. The assembly of claim 1, wherein the rotary assembly comprises a rotary selector, a bevel gear assembly and a deck height spacer,
wherein the rotary selector is operably coupled to the bevel gear assembly to transmit torque from the rotary selector to the bevel gear assembly, and
wherein the bevel gear assembly is operably coupled to the deck height spacer to transmit torque from the rotary selector to the deck height spacer.

3. The assembly of claim 2, wherein the carriage assembly comprises a pedal and a height selector arm, and
wherein the pedal is operably coupled to the height selector arm such that the height selector arm moves from an engaged state with the deck height spacer to a disengaged state responsive to the operator engaging the pedal.

4. The assembly of claim 3, wherein the carriage assembly further comprises a pivot bar, a first bell crank, a second bell crank, a third bell crank and a fourth bell crank,
wherein the pivot bar operably couples the pedal to the first bell crank at a first end of the pivot bar and to the second bell crank at a second end of the pivot bar,
wherein the first bell crank is operably coupled to the third bell crank via a first linking rod and the second bell crank is operably coupled to the fourth bell crank via a second linking rod, and
wherein the first bell crank, the second bell crank, the third bell crank and the fourth bell crank are each operably coupled to the cutting deck and configured to lift the cutting deck responsive to the operator engaging the pedal.

5. The assembly of claim 4, wherein the height selector arm is integrated into the fourth bell crank,
wherein the first bell crank moves the third bell crank via the first linking rod responsive to the operator engaging the pedal, and
wherein the second bell crank moves the fourth bell crank via the second linking rod responsive to the operator engaging the pedal.

6. The assembly of claim 5, wherein the deck height spacer comprises a cylindrical body operably coupled to the bevel gear assembly,
wherein the cylindrical body comprises a circumferential surface that extends in an axial direction, a base portion and a plurality of radial segments, and
wherein the circumferential surface of the cylindrical body comprises a step-like structure wherein each of the plurality of radial segments is disposed a greater distance away from the base portion than a previous radial segment in a clockwise direction around the circumferential surface.

7. The assembly of claim 6, wherein the height selector arm is configured to contact the deck height spacer at one of the plurality of radial segments when the height selector arm is in the engaged state, and
wherein each radial segment comprises a retaining lip protruding in the axial direction perpendicular to the base portion to retain the height selector arm in the engaged state.

8. The assembly of claim 2, wherein the rotary assembly further comprises a feedback mechanism configured to provide tactile feedback to the rotary selector responsive to the operator turning the rotary selector,
wherein the feedback mechanism comprises a washer and projections on a surface of the bevel gear assembly,
wherein the washer is biased towards the projections and provides a feedback response to the operator responsive to passing a projection as the bevel gear turns.

9. The assembly of claim 8, wherein the rotary selector comprises a selection indicator that aligns with a height indication on a portion of the frame as the rotary selector is turned by the operator.

10. The assembly of claim 6, wherein the deck height spacer further comprises a reference protrusion on the base portion that is configured to align with a reference notch in the bevel gear assembly to assist with installing the rotary assembly in a proper orientation.

11. A riding lawn care vehicle comprising:
a frame to which wheels of the riding lawn care vehicle are attachable;
a seat in which an operator of the riding lawn care vehicle may be positioned when operating the riding lawn care vehicle;
a cutting deck operably coupled to the frame and comprising a cutting blade and a housing frame, wherein the housing frame is configured to support a housing inside which the cutting blade is housed; and
a deck height adjustment assembly comprising a carriage assembly and a rotary assembly, wherein the carriage assembly and the rotary assembly are operable by the operator positioned in the seat.

12. The riding lawn care vehicle of claim 11, wherein the rotary assembly comprises a rotary selector, a bevel gear assembly and a deck height spacer,
wherein the rotary selector is operably coupled to the bevel gear assembly to transmit torque from the rotary selector to the bevel gear assembly, and
wherein the bevel gear assembly is operably coupled to the deck height spacer to transmit torque from the rotary selector to the deck height spacer.

13. The riding lawn care vehicle of claim 12, wherein the carriage assembly comprises a pedal and a height selector arm, and
wherein the pedal is operably coupled to the height selector arm such that the height selector arm moves from an engaged state with the deck height spacer to a disengaged state responsive to the operator engaging the pedal.

14. The riding lawn care vehicle of claim 13, wherein the carriage assembly further comprises a pivot bar, a first bell crank, a second bell crank, a third bell crank and a fourth bell crank,
wherein the pivot bar operably couples the pedal to the first bell crank at a first end of the pivot bar and to the second bell crank at a second end of the pivot bar,
wherein the first bell crank is operably coupled to the third bell crank via a first linking rod and the second bell crank is operably coupled to the fourth bell crank via a second linking rod, and
wherein the first bell crank, the second bell crank, the third bell crank and the fourth bell crank are each operably coupled to the cutting deck and configured to lift the cutting deck responsive to the operator engaging the pedal.

15. The riding lawn care vehicle of claim 14, wherein the height selector arm is integrated into the fourth bell crank,
wherein the first bell crank moves the third bell crank via the first linking rod responsive to the operator engaging the pedal, and
wherein the second bell crank moves the fourth bell crank via the second linking rod responsive to the operator engaging the pedal.

16. The riding lawn care vehicle of claim 15, wherein the deck height spacer comprises a cylindrical body operably coupled to the bevel gear assembly,
wherein the cylindrical body comprises a circumferential surface that extends in an axial direction, a base portion and a plurality of radial segments, and
wherein the circumferential surface of the cylindrical body comprises a step-like structure wherein each of the plurality of radial segments is disposed a greater distance away from the base portion than a previous radial segment in a clockwise direction around the circumferential surface.

17. The riding lawn care vehicle of claim 16, wherein the height selector arm is configured to contact the deck height spacer at one of the plurality of radial segments when the height selector arm is in the engaged state, and
wherein each radial segment comprises a retaining lip protruding in the axial direction perpendicular to the base portion to retain the height selector arm in the engaged state.

18. The riding lawn care vehicle of claim 12, wherein the rotary assembly further comprises a feedback mechanism configured to provide tactile feedback to the rotary selector responsive to the operator turning the rotary selector,
wherein the feedback mechanism comprises a washer and projections on a surface of the bevel gear assembly,
wherein the washer is biased towards the projections and provides a feedback response to the operator responsive to passing a projection as the bevel gear turns.

19. The riding lawn care vehicle of claim 18, wherein the rotary selector comprises a selection indicator that aligns with a height indication on a portion of the frame as the rotary selector is turned by the operator.

20. The riding lawn care vehicle of claim 16, wherein the deck height spacer further comprises a reference protrusion on the base portion that is configured to align with a reference notch in the bevel gear assembly to assist with installing the rotary assembly in a proper orientation.
